(19) United States
(12) Patent Application Publication
(10) Pub. No.: US 2013/0073105 A1
(43) Pub. Date: Mar. 21, 2013

(54) SYSTEM AND METHODS FOR RENEWABLE POWER NOTIFICATIONS

(71) Applicants: James J. Schmid, Kirkland, WA (US); Jerry Steven Massey, Atlanta, GA (US); Mark Joseph Meyerhofer, Atlanta, GA (US); Sthitaprajna Acharya, Atlanta, GA (US); Osahun Igunbor, Atlanta, GA (US)

(72) Inventors: James J. Schmid, Kirkland, WA (US); Jerry Steven Massey, Atlanta, GA (US); Mark Joseph Meyerhofer, Atlanta, GA (US); Sthitaprajna Acharya, Atlanta, GA (US); Osahun Igunbor, Atlanta, GA (US)

(21) Appl. No.: 13/237,721

(22) Filed: Sep. 20, 2011

(51) Int. Cl. G06F 1/32; G06F 15/16; G06F 1/28

(52) U.S. Cl. 700/295; 709/204; 709/203

(57) ABSTRACT

Systems and methods relating to renewable power notifications to alert consumers when renewable power becomes more available are provided. Specifically, renewable power generation may depend on changing conditions such as weather. As such, a system according to the present disclosure may involve a network interface and a processor, the network interface receiving a message relating to renewable power generation and sending a renewable power notification to a consumer. The processor may run a system that includes a component to detect renewable power availability based at least in part on the message, a component to determine whether to issue the renewable power notification to the consumer based at least in part on the availability of the renewable power generation, and a component to cause the network interface to issue the renewable power notification to the consumer.

### BACKGROUND

The subject matter disclosed herein relates to a demand response system to notify consumers when renewable power generation is available.

The availability of renewable power may depend on changing environmental conditions. As such, renewable power generation may not be as regular as conventional power sources like coal and natural gas. Solar power, for example, may be abundant in sunny conditions, but scarce in cloudy weather. Likewise, wind power may be abundant during periods of harvestable wind, but may be completely unavailable when the air is still or the wind excessively high. Although a consumer may desire to rely as much as possible on renewable energy sources, the variability of renewable power makes it very difficult for consumers to determine the source of the power they consume.

### BRIEF DESCRIPTION

Certain embodiments of the present disclosure are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system according to the present disclosure may involve a network interface and a processor, the network interface receiving a message relating to renewable power generation and sending a renewable power notification to a consumer. The processor may run a system that includes a component to detect renewable power availability based at least in part on the message, a component to determine whether to issue the renewable power notification to the consumer based at least in part on the availability of the renewable power generation, and a component to cause the network interface to issue the renewable power notification to the consumer.

In a second embodiment, one or more tangible, machine-readable media may include processor-executable instructions. These instructions may include instructions to receive a renewable power generation indication relating to renewable power generation on a power grid and instructions to determine, based on the indication, a current or expected amount of renewable power generation supplied to the power grid. The instructions may also include instructions to receive customer enrollment preferences that indicate whether a consumer desires to be notified based at least in part on the current or expected amount of renewable power generation and instructions to compare the customer enrollment preferences to the current or expected amount of renewable power generation. The instructions may also include instructions to cause a notification to be issued to the consumer when the customer enrollment preferences indicate the consumer desires to receive the notification.

In a third embodiment, a method includes receiving in a power meter a renewable power notification from a utility indicating that renewable power has met or exceeded a threshold. The method also includes issuing a control signal from the power meter to control a load to cause the load to consume more power upon receipt of the renewable power notification.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram representing an electrical distribution system that can notify consumers when certain renewable power generation is available, in accordance with an embodiment;

FIG. 2 is a block diagram of a smart meter that may be used in the electrical distribution system of FIG. 1, in accordance with an embodiment;

FIG. 3 is a block diagram of a demand response system of the electrical distribution system of FIG. 1 that can notify consumers when certain renewable power generation is available, in accordance with an embodiment;

FIG. 4 is a block diagram representing an embodiment of a demand response renewable power notification system that may be employed by the demand response system of FIG. 3, in accordance with an embodiment;

FIG. 5 is a schematic diagram illustrating consumer preferences that may be considered by the renewable power notification system of FIG. 4, in accordance with an embodiment;

FIG. 6 is a flowchart of a method for determining when to notify a consumer that renewable power generation is available, in accordance with an embodiment; and

FIG. 7 is a flow diagram illustrating a manner in which the smart meter of FIG. 2 may control the operation of certain consumer loads in response to a renewable power notification system, in accordance with an embodiment.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Many consumers may desire to increase their consumption of renewable energy and reduce their reliance on other energy sources, such as fossil fuels. Accordingly, embodiments of the present disclosure relate to systems and methods to notify consumers when renewable power generation becomes available, allowing consumers to adjust their power consumption as desired. In particular, unlike traditional power generation based on fossil fuels, much renewable power generation may depend on changing environmental conditions. For example, solar power generation may vary heavily on the time of day and/or year, as well as the amount of cloud cover at the site of the solar power generation facility. Likewise, wind power generation may depend heavily on the strength of the wind.

According to present embodiments, a utility may employ a demand response system that runs a renewable power notification system to determine when such variable renewable power generation is online or is expected to come online. The utility may issue a renewable power notification to consumers who desire to consume a greater amount of environmentally friendly power (e.g., renewable power such as solar or wind). Thus, a consumer may choose to operate appliances that consume significant amounts of power (e.g., clothes washer, clothes dryer, or dish washer) and/or to charge large batteries (e.g., an electric car) only when a significant amount of renewable energy generation is available. In one example, a smart power meter located with the consumer may issue control signals to activate or deactivate such loads depending on these notifications. The smart meter may automatically increase power consumption when renewable power generation is online and/or automatically decrease power consumption when the renewable energy sources are not online.

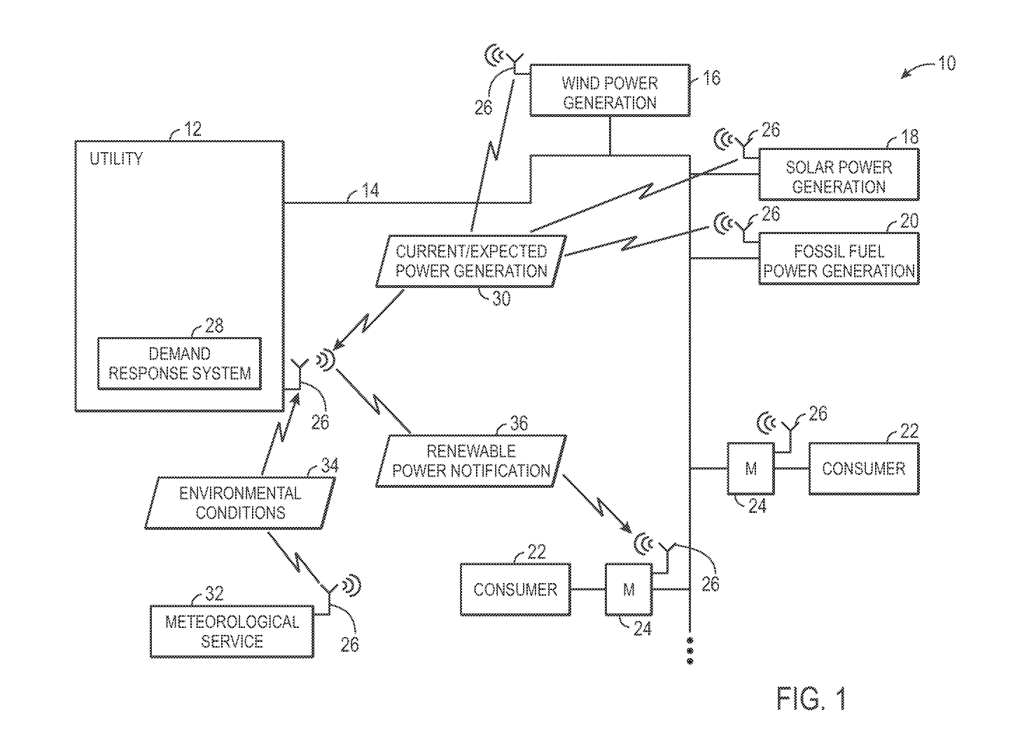

With the foregoing in mind, FIG. 1 illustrates an electrical distribution system 10 controlled by a utility 12 that can notify consumers when environmentally friendly energy sources are generating power. As shown in FIG. 1, a power grid 14 under the control of the utility 12 may supply power deriving from multiple different power generation facilities. These power generation facilities may include renewable power generation facilities and/or nonrenewable power generation facilities. For instance, a wind power generation facility 16 may generate electrical power from wind and a solar power generation facility 18 may generate electrical power from light and/or heat from the sun. Although not shown particularly in FIG. 1, other renewable power generation facilities that may supply power on the power grid 14 may include geothermal power generation facilities, biofuel power generation facilities, hydro power generation facilities, and others. Indeed, any suitable renewable power generation facilities may provide power on the power grid 14.

Typically, the amount of power that can be generated by renewable power generation may be constrained by changing environmental conditions (e.g., weather at the power generation facilities 16 and/or 18, geological variations at a geothermal facility, and so forth). As such, additional nonrenewable power generation facilities may provide other power, generally providing the majority of power supplied on the power grid 14. Nonrenewable power generation facilities may include, for example, a fossil fuel power generation facility 20. The fossil fuel power generation facility 20 may generate power, for example, by burning coal, natural gas, and/or fuel oil. Other generally nonrenewable power sources used by the power grid 14 may include, for example, nuclear power generation facilities.

Commercial and/or residential consumers 22 may receive power from the power grid 14. Power meters at consumer 22 sites, such as smart power meters 24, may monitor the amount of power consumed by each respective consumer 22. Communication circuitry 26 of the smart power meters 24 may permit communication with the utility 12, which also may include similar communication circuitry 26. The utility 12 also may communicate with the various power generation facilities via respective communication circuitry 26. By way of example, the communication circuitry 26 may permit communication via a wireless mesh protocol such as the ZigBee protocol. Additionally or alternatively, the communication circuitry 26 may permit communication using any other suitable technique. For example, the communication circuitry 26 may permit communication via a cellular network (e.g., a 3G or 4G network) and/or via a wired network (e.g., fiber optic and/or coaxial cable).

The utility 12 may employ a demand response system 28. The demand response system 28 may represent, for example, a Demand Response Management System (DRMS) by General Electric Company. As discussed in greater detail below, the demand response system 28 may employ a renewable power notification system to notify consumers 22 when renewable power generation becomes available. For example, the utility 12 may receive indications of current and/or expected power generation from the wind power generation facility 16 and/or the solar power generation facility 18. Additionally or alternatively, a meteorological service 32 and/or meteorological instruments may provide an indication of current and/or expected environmental conditions 34 that could impact the amount of renewable power generated. By way of example, such environmental conditions 34 may include the current and/or predicted intensity of wind at the wind power generation facility 16 site and/or sun at the solar power generation facility 18 site.

Using this information and/or other relevant information, the demand response system 28 may determine when the amount of renewable power generation is currently or is expected to become significant. The demand response system 28 then may alert consumers 22 who desire to increase their consumption of renewable power and/or reduce their consumption of nonrenewable power. To provide one example, when sunny weather at the solar power generation facility 18 indicates the expected amount of solar power generation will exceed some threshold, the utility 12 may issue a renewable power notification 36 to a participating consumer 22. In the example of FIG. 1, the renewable power notification 36 is sent to the smart meter 24 of the consumer 22. Additionally or alternatively, the utility 12 may send the renewable power notification 36 directly or indirectly to the consumer 22 via email, a text message, phone, and/or a message on an online social network, to name a few examples.

When the consumer 22 receives the renewable power notification 36, the consumer 22 may adjust current or future power consumption as desired. For example, when the renewable power notification 36 indicates that the amount of renewable power is currently or is expected to be relatively higher, the consumer 22 may plan to operate certain appliances (e.g., a clothes washer, a clothes dryer, and/or a dishwasher) and/or charge certain devices (e.g., an electric car). When the renewable power notification 36 indicates that the amount of renewable power is currently or is expected to be relatively lower, the consumer 22 may plan to reduce power consumption accordingly. In addition, in certain examples described further below, a smart meter 24 may automatically adjust consumer 22 power consumption upon receipt of renewable power notifications 36.

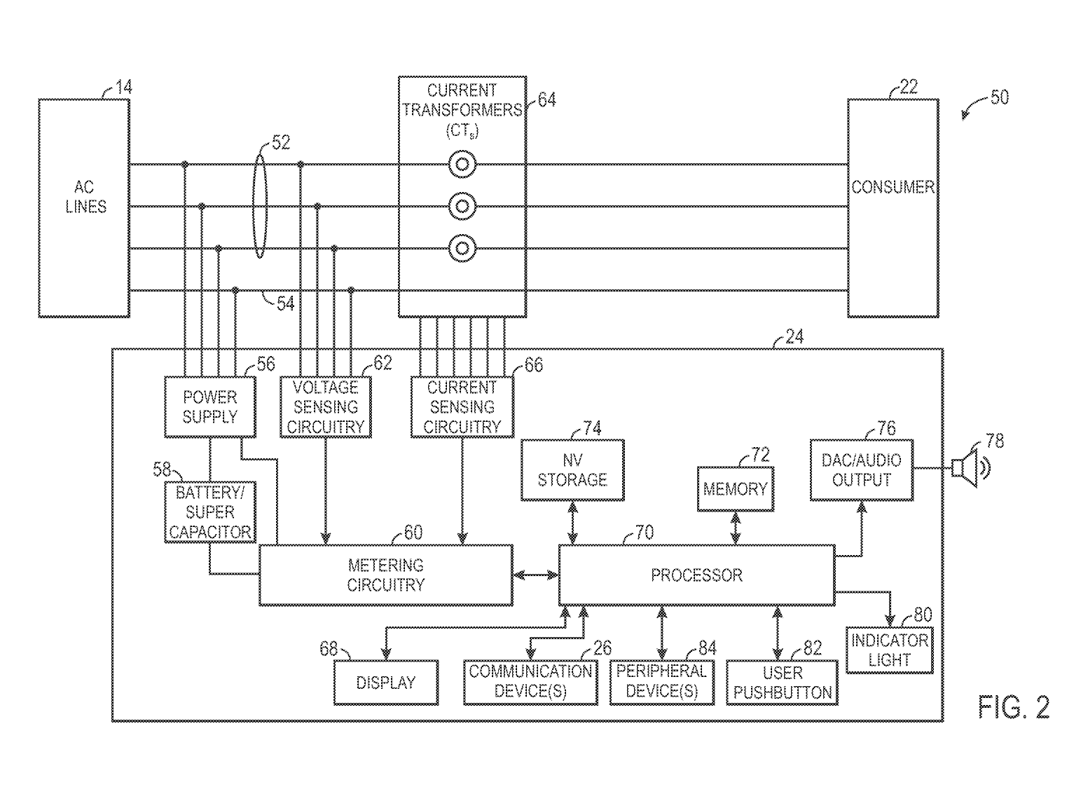

As mentioned above, in some embodiments, a smart meter 24 may interface with the power grid 14 and, in some cases, communicate with the utility 12. One example of a smart meter 24 appears in FIG. 2 in a power meter system 50. Joined to the power grid 16, the smart meter 24 monitors power flowing from AC lines 52 and 54 of the power grid 14 to an AC load (e.g., a residential, commercial, or industrial asset owned by a consumer 22). Although the embodiment of FIG. 2 involves monitoring three-phase power, alternative embodiments of the smart meter 24 may monitor single-phase power. In the illustrated embodiment, the AC lines 52 and 54 of the power grid 14 may transmit three-phase power via three phase lines 52 and a neutral line 54. The smart meter 24 may obtain power via power supply circuitry 56 that may couple to the three phase lines 52 and the neutral line 54 for its internal power consumption. To back up power consumption data in the event of a power outage, the power supply circuitry 56 also may charge a battery and/or super capacitor 58. In alternative embodiments, the backup power may be fed by a non-rechargeable battery.

Metering circuitry 60 may ascertain power consumption by monitoring the voltage and current traversing the AC lines 14 to the AC load (e.g., the consumer 22). In particular, voltage sensing circuitry 62 may determine the voltage based on the three phase lines 52 and the neutral line 54. Current transformers (CTs) 64 and current sensing circuitry 66 may determine the current flowing through the three phase lines 52. The metering circuitry 60 may output the current power consumption values to an electronic display 68, such as a liquid crystal display (LCD), as well as to a processor 70. The metering circuitry 60 may sense the voltage and current inputs and send corresponding pulses to the processor 70, which calculates various data relating to the current power consumption of the consumer 22. For example, the processor 70 may calculate the energy accumulation, power factor, active power, reactive power and maximum demand, etc.

The processor 70 may store the demand details in memory 72 and/or nonvolatile storage 74, which may be NVRAM (EEPROM) or other suitable nonvolatile storage. In certain embodiments, multiple functions of the smart meter 24 may be implemented in a single chip solution, in which a single chip performs both the voltage/current sensing and the calculation of demand parameters. Certain audio alerts may be provided by the processor 70 to audio output circuitry 76 and/or 78, which may include a digital-to-analog converter (DAC) and a built-in speaker or external powered speakers connected by the consumer 22. These audio alerts may include, for example, an indication that the utility provider 14 has sent a demand response event request such as a renewable power notification 36.

The processor 70 may include one or more microprocessors, such as one or more “general-purpose” microprocessors, one or more application-specific processors (ASICs), or a combination of such processing components, which may control the general operation of the smart meter 24. For example, the processor 70 may include one or more instruction set processors (e.g., RISC), audio processors, and/or other related chipsets. The memory 72 and the nonvolatile storage 74 may provide instructions to enable the processor 70 to control the smart meter 24 and process the renewable power notification 36.

The processor 70 may be operably coupled to the memory 72 and/or the storage 74 to carry out the presently disclosed techniques. These techniques may be carried out by the processor 70 and/or other data processing circuitry based on certain instructions executable by the processor 70. Such instructions may be stored using any suitable article of manufacture, which may include one or more tangible, computer-readable media to least collectively store these instructions. The article of manufacture may include, for example, the memory 72 and/or the nonvolatile storage 74. The memory 72 and the nonvolatile storage 74 may include any suitable articles of manufacturer for storing data and executable instructions, such as random-access memory, read-only memory, rewriteable flash memory, hard drives, and/or optical discs.

To interface with the consumer 22, the processor 70 may cause an indicator light 80 to blink or flash or may display messages on the display 68. By way of example, such a message may include a demand response event request such as a renewable power notification 36. The consumer 22 may respond by pressing a user pushbutton 82 or via a peripheral device 84, such as a computing device (e.g., computer or portable phone) or an input device (e.g., a keyboard or touch-sensitive screen). These components of the smart meter 24, including the display 68 and the audio output circuitry 76 and/or 78, generally may represent the interface circuitry of the smart meter 24. The communication circuitry 26 may include, as generally noted above, interfaces for a personal area network (PAN) such as a Bluetooth network, a local area network (LAN) such as an 802.11x Wi-Fi network, a wide area network (WAN) such as a 3G or 4G cellular network (e.g., WiMax), an infrared (IR) communication link, a Universal Serial Bus (USB) port, and/or a power line data transmission network such as Power Line Communication (PLC) or Power Line Carrier Communication (PLCC). As will be described below, the smart meter 24 may also control certain loads of the consumer 22 based on renewable power notifications 36. Controlling these loads may involve communicating with the loads using a LAN (e.g., Wi-Fi) and/or a home power line network (e.g., X10).

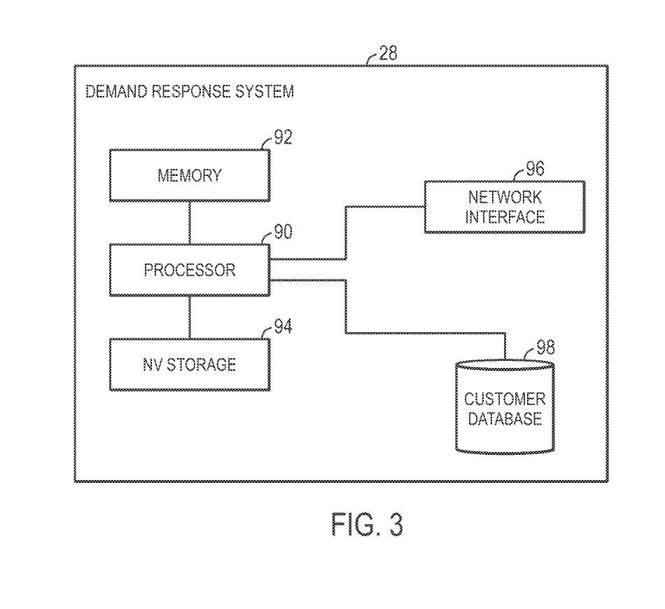

The demand response system 28 employed by the utility 12 similarly may include certain data processing circuitry, which may enable the demand response system 28 to employ a renewable power notification system, which may be implemented as hardware, processor-executable instructions, or a combination thereof. One embodiment of a demand response system 28 appears in FIG. 3. The functional blocks of the demand response system 28 are merely intended to represent by example certain elements that could appear in a particular implementation. In other implementations, the demand response system 28 may have more or fewer components, as may be desired. By way of example, demand response system 28 may be a server, desktop, or notebook computer that has been configured to determine and/or communicate renewable power notifications 36 to participating consumers 22.

In the demand response system 28, a processor 90 and/or other data processing circuitry may be operably coupled to memory 92 and storage 94 to execute instructions for carrying out the presently disclosed techniques. These instructions may be encoded in programs that may be executed by the processor 90. The instructions may be stored in any suitable article of manufacture that includes one or more tangible, computer-readable medium that at least collectively stores these instructions or routines, such as the memory 92 or the storage 94. The memory 92 and/or the storage 94 may include, for example, random-access memory, read-only memory, rewriteable memory, a hard drive, and/or optical discs.

The demand response system 28 may also include input/output (I/O) ports such as a network interface 96. The network interface 96 may provide communication through communication circuitry 26 (e.g., a personal area network (PAN) such as a Bluetooth network, a local area network (LAN) such as an 802.11x Wi-Fi network, a wide area network (WAN) such as a 3G or 4G cellular network (e.g., WiMax), an infrared (IR) communication link, a Universal Serial Bus (USB) port, and/or a power line data transmission network such as Power Line Communication (PLC) or Power Line Carrier Communication (PLCC)). As should be appreciated, the demand response system 28 may include a variety of other components, such as a power supply, a keyboard, a mouse, a track pad, and/or a touch screen interface. Also, the demand response system 28 may be, or may be associated with, a utility control system used by the utility 12 to control the operation of components of the power grid 14. A customer database 98, which may be located within or remote from the demand response system 28 (e.g., in the nonvolatile storage 94 or apart from the demand response system 28), may provide the demand response system 28 with customer data. The customer database 98 may permit the demand response system 28 to determine when and to whom to send renewable power notifications 36.

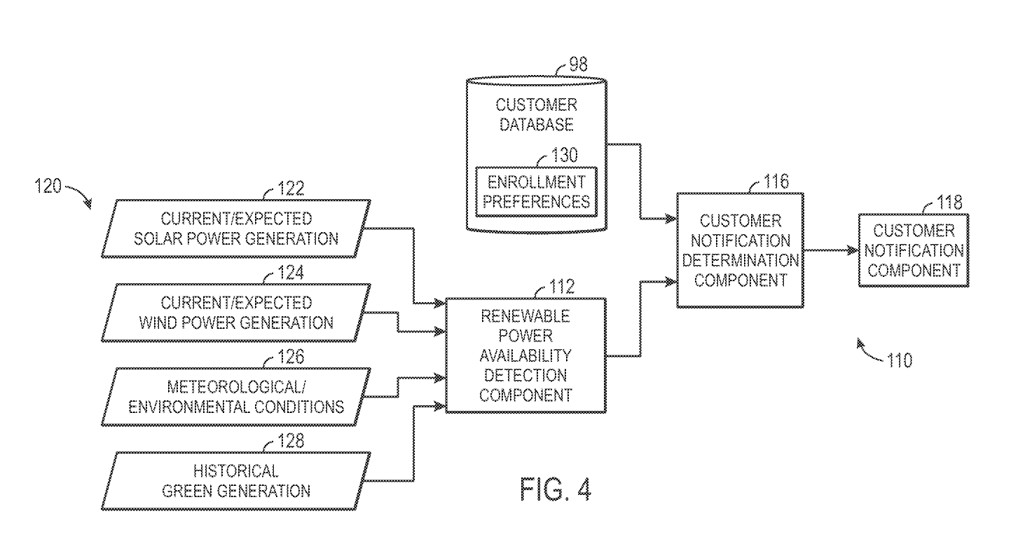

The demand response system 28 may run a renewable power notification system, an example of which appears in FIG. 4. Specifically, FIG. 4 illustrates a renewable power notification system 110 that includes a renewable power availability detection component 112, the customer database 98, a customer notification determination component 114, and a customer notification component 116. These components may be implemented as hardware, processor-executable instructions (e.g., software or firmware), or a combination of hardware and processor-executable instructions.

The renewable power availability detection component 112 may receive a variety of renewable power generation indications 120. The renewable power generation indications 120 illustrated in FIG. 4 are intended to represent the type of data that may be considered by the renewable power availability detection component 112, and are not intended to be exhaustive. Among other things, these renewable power generation indications 120 may include the current and/or expected solar power generation indication 122 from the solar power generation facility 18 and a current and/or expected wind power generation indication 124 from the wind power generation facility 16. Similar indications may be provided by other renewable power generation facilities when such facilities are present in the electrical distribution system 10.

Additionally or alternatively, the renewable power generation indications 120 may include meteorological and/or environmental conditions indications 126. The meteorological and/or environmental conditions 126 may include, among other things, the current or predicted amount of wind at the wind power generation facility 16 or the current or predicted intensity of the sun at the solar power generation facility 18. When other renewable power generation facilities are present in the electrical distribution system 10, other related meteorological and/or environmental conditions may be provided in a meteorological and/or environmental conditions indication 126. For example, the meteorological and/or environmental conditions 126 may include the current or predicted geothermal conditions in the vicinity of a geothermal power generation facility (e.g., the temperature of the water). In another example, the meteorological and/or environmental conditions 126 may include the current or predicted amount of water flowing through a hydro power generation facility.

Another of the renewable power generation indications 120 may include, for example, historical renewable power generation indications 128. The historical renewable power generation indications 128 may represent historical power generation data from various power generation facilities in the electrical distribution system 10 and/or historical meteorological and/or environmental data. The renewable power availability detection component 112 may use the historical renewable power generation indications 128 to more precisely identify current or future renewable power generation. By way of example, the historical renewable power generation indication 128 may allow the renewable power availability detection component 112 to identify power generation trends. For example, the renewable power availability detection component 112 may use the historical renewable power generation indications 128 to compare the actual amount of power generated by the wind power generation facility 16 and/or the solar power generation facility 18 that occurred during actual historical environmental conditions. Such a comparison may be useful to identify current or future renewable power generation in view of the meteorological and/or environmental conditions 126. In another example, the renewable power availability detection component 112 may use the historical renewable power generation indications 128 to predict times of the day, week, and/or year when renewable power generation is most likely to occur.

Based at least partly on at least one of the renewable power generation indications 120, the renewable power availability detection component 112 may ascertain a current and/or expected amount of renewable power generation. The renewable power availability detection component 112 may ascertain the current and/or expected amount of renewable power generation using any suitable technique, including those mentioned above. In some cases, the renewable power availability detection component 112 may further distinguish between specific types of renewable power, percentage of total power due to renewable power, percentage of total power due to carbon-based power, and so forth. For example, the renewable power availability detection component 112 may compare the amount of renewable power currently being generated by the wind power generation facility 16 and/or solar power generation facility 18 to the amount of power being generated by the fossil fuel power generation facility 20 to determine a percentage of total power deriving from renewable sources or a percentage of total power deriving from carbon-based sources.

From the current and/or expected renewable power generation, the customer notification determination component 114 may determine which, if any consumers 22 should be notified. The customer notification determination component 114 may review enrollment preferences 130 of the customer database 98 to determine whether, when, and how to notify enrolled consumers 22. The customer notification component 116 may send renewable power notifications 36 to consumers 22 as determined by the customer notification determination component 114. It may be appreciated that some renewable power notifications 36 may indicate that renewable power generation has surpassed some threshold or has fallen beneath some threshold. That is, certain renewable power notifications 36 may notify a consumer 22 that renewable power generation has increased beyond the threshold, which may be a threshold requested by the consumer 22. Other renewable power notifications 36 may notify the consumer 22 that renewable power generation has decreased to beneath the threshold.

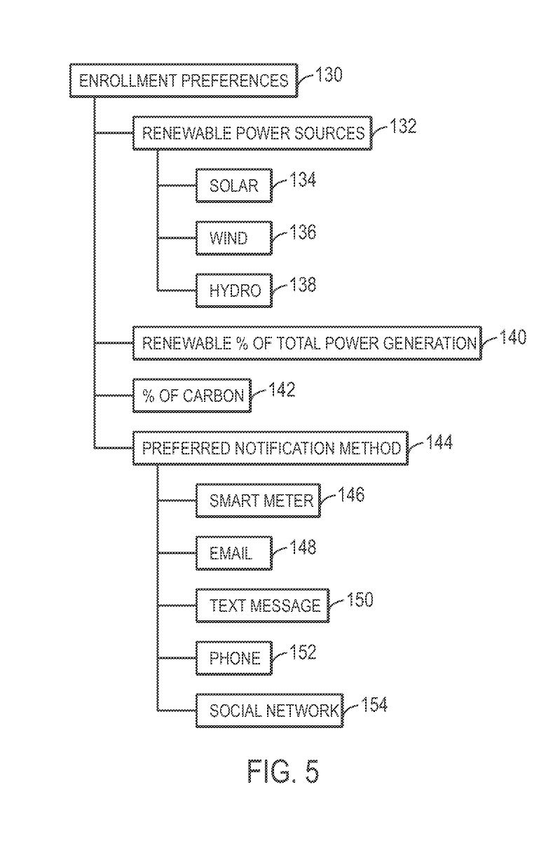

Whether or when the customer notification determination component 114 determines to issue a renewable power notification 36 to a consumer 22 may depend on the enrollment preferences 130 in the customer database 98. Some examples of enrollment preferences 130 appear in FIG. 5. These enrollment preferences 130 should be understood to be provided by way of example, and are intended to be illustrative and not exhaustive. Indeed, more or fewer enrollment preferences 130 may be employed. Moreover, not all of the enrollment preferences 130 may be used with each consumer 22.

For example, the enrollment preferences 130 may indicate whether a consumer 22 is interested in being notified when a significant amount of renewable power sources 132 are being generated. That is, a consumer 22 may not be notified if that consumer 22 is not enrolled in a program to receive renewable power notifications 36. In some embodiments, the consumer 22 may further specify the types of renewable power sources that the consumer 22 would like to be notified about. For example, a consumer may indicate that they are interested in being notified when some threshold amount of solar power generation 134, wind power generation 136, and/or hydro power generation 138, or other renewable power generation such as geothermal power generation, is currently or is expected to become available.

The enrollment preferences 130 may include a consumer-selectable threshold 140 of the percentage of total power generation that derives from renewable power sources. For instance, a consumer 22 may elect to receive renewable power notifications 36 only when the percentage of total power generation deriving from renewable power sources exceeds some desired value. Additionally or alternatively, the enrollment preferences 130 may include a consumer-selectable threshold 142 of the percentage of total power generation due to carbon-based sources. Via the consumer-selectable threshold 142, a consumer 22 may elect to receive renewable power notifications 36 indicating when the percentage of the total power generation due to carbon-based sources is currently or is expected to be beneath a desired threshold. Another example of the consumer-selectable threshold 142 may relate to the carbon emissions resulting from the amount of power being generated. For instance, as the percentage of total power being generated is due increasingly to carbon-based sources, the amount of carbon per kWh of power may increase. According to the consumer-selectable threshold 142, the demand response system 28 may issue renewable power notifications 36 indicating when the amount of carbon per kWh is beneath the threshold. In addition, the enrollment preferences 130 may include a preferred notification method 144. As mentioned above, may desire to receive the renewable power notification 36 at the smart meter 146, by email 148, by text message 150, by phone 152, and/or by a social network or social media message 154 (e.g., a Facebook or Twitter message), to name a few examples.

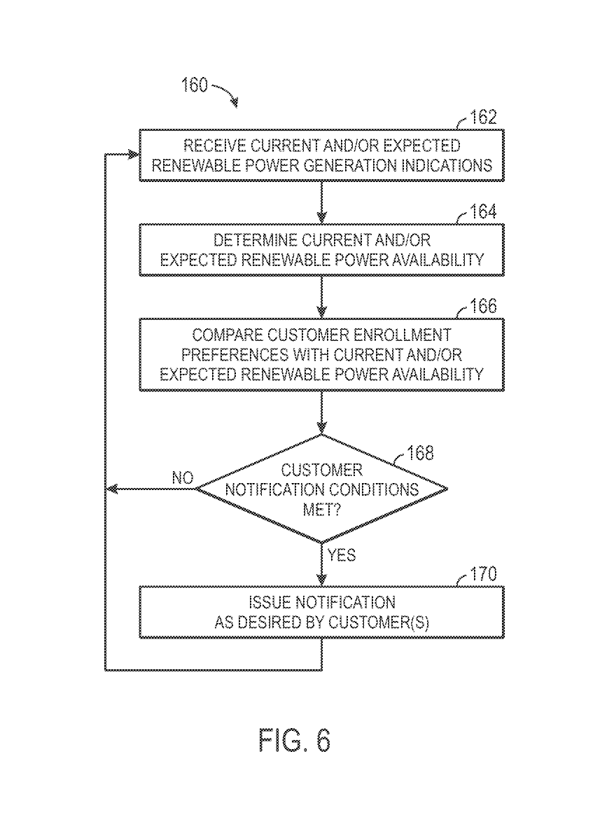

A flowchart 160 of FIG. 6 represents an example of a method for generating a renewable power notification 36. The flowchart 160 may begin when the demand response system 28 receives the current and/or expected renewable power generation indications 120 (block 162). Using the renewable power generation indications 120 and/or other data regarding the electrical distribution system 10 (e.g., the total amount of power and/or the amount of power generated by the fossil fuel power generation facility 20), the demand response system 28 may determine a current and/or expected renewable power availability (block 164). By comparing the customer enrollment preferences with the current and/or expected renewable power availability (block 166), the demand response system 28 may determine whether to issue a renewable power notification 36. In particular, if customer notification conditions are meet (decision block 168), the demand response system 28 may issue the renewable power notification 36 in the manner designated by the utility 12 and/or the consumer 22 (block 170). Otherwise, the demand response system 28 may return to block 162. It should be understood that renewable power notifications 36 may be sent to indicate when renewable power is currently or is expected to become more available (e.g., exceeds a threshold), as well as when the renewable power is currently or is expected to become less available (e.g., falls beneath the threshold).

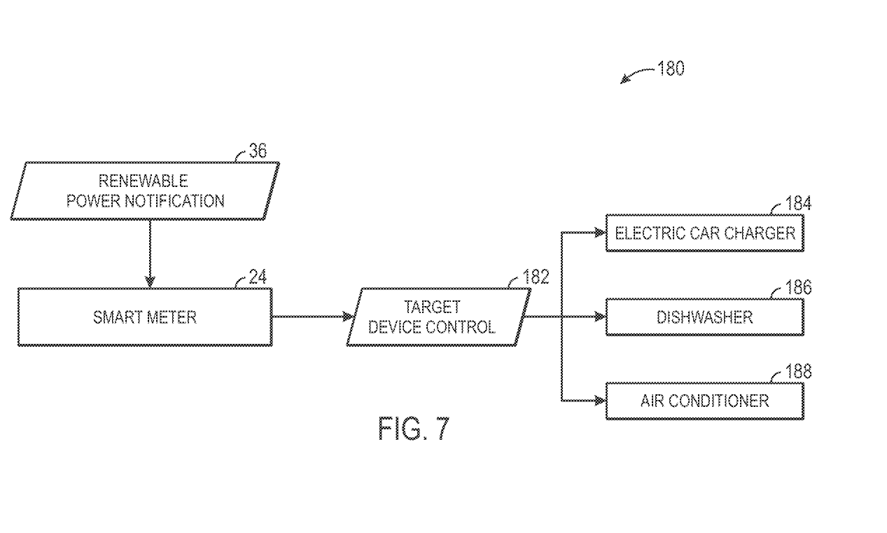

When a consumer 22 receives a renewable power notification 36 indicating renewable power is available, that consumer 22 may decide to temporarily increase power consumption to take advantage of the additional renewable power being generated. As mentioned above, the consumer 22 may do so manually. Additionally or alternatively, a smart meter 24 may automatically adjust consumer 22 power consumption. For example, as shown in FIG. 7, an automatic renewable power response system 180 may involve the automatic activation and/or deactivation of certain appliances or devices when the utility 12 issues a renewable power notification 36. Namely, the utility 12, via the demand response system 28, may issue the renewable power notification 36 when the amount of renewable power being generated matches the enrollment preferences 130 of the consumer 22. Based at least partly on renewable power notifications 36, the smart meter 24 may activate and deactivate certain appliances or devices automatically. In the example of FIG. 7, the smart meter 24 may issue a target device activation signal 182 via a wired or wireless connection to an electric car charger 184, a dishwasher 182, and/or an air conditioner 184. Such wired or wireless connections may include, for example, a home power line network (e.g., X10) or a local area network (e.g., Wi-Fi).

The target device activation signal 182 may activate or increase the power consumption of a target appliance (e.g., the electric car charger 184, the dishwasher 182, and/or the air conditioner 184) when the target device activation signal 182 is provided by the smart meter 24. The smart meter 24 may provide the target device activation signal 182 upon receipt of a renewable power notification 36 indicating that renewable power generation meets the enrollment preferences 130 of the consumer 22 (e.g., has increased beyond a threshold). The target device activation signal 182 may deactivate or decrease the power consumption of the target appliance when generated upon receipt of a renewable power notification 36 indicating that renewable power generation no longer meets the enrollment preferences 130 of the consumer 22 (e.g., has decreased below the threshold). Also, as noted above, a renewable power notification 36 may relate to expected renewable power generation at a future time. The smart meter 24 may employ such renewable power notifications 36 to schedule when to issue target device activations signals 182.

By powering some devices and appliances when renewable power generation is available, a consumer 22 may effectively reduce their dependence on conventional power sources. For instance, charging an electric vehicle battery only at these times may allow a consumer 22 to truly drive a zero-emissions electric vehicle. Moreover, using the target device activation signal 182 to cause some appliances, such as the dishwasher 186 or the air conditioner 188, to vary their operation to efficiently use renewable power. For example, the dishwasher 186 may turn on overnight, at a time when the amount of wind power becomes significant. Without a renewable power notification 36, the consumer 22 might not otherwise be aware or interested in operating certain appliances at this time. Similarly, the air conditioner 188 thermostat may be changed depending on renewable power notifications 36. For example, the thermostat of the air conditioner 188 may be automatically set to a lower temperature when the renewable power is more widely available, as indicated by a renewable power notification 36. Otherwise, the air conditioner 188 thermostat may be set to a higher temperature when renewable power sources are not as widely available to consume less nonrenewable power.

Technical effects of the present disclosure include, among other things, allowing a consumer to adjust their power consumption based on the availability of renewable power sources. Namely, notifying a consumer when renewable power is available may allow the consumer to adjust power consumption in response. For example, the consumer may increase the amount of power consumption attributable to renewable power sources while reducing power consumption attributable to nonrenewable or fossil fuel sources. A smart meter that can receive renewable power notifications may automatically adjust the power consumption of the consumer. When consumers are empowered to make power consumption decisions based on the availability of renewable or “green” power, the market for such power sources may also improve.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
a network interface configured to receive a message relating to renewable power generation supplied to a power grid and to issue a renewable power notification to a consumer of power of the power grid, wherein the renewable power notification indicates a state of the renewable power generation supplied to the power grid; and
a processor configured to run a renewable power notification system comprising:
a renewable power availability detection component configured to determine an availability of renewable power generation supplied to a power grid based at least in part on the message;
a customer notification determination component configured to determine whether to issue the renewable power notification to the consumer based at least in part on the availability of the renewable power generation; and
a customer notification component configured to cause the network interface to issue the renewable power notification to the consumer when the customer notification determination component determines to issue the notification.

2. The system of claim 1, wherein the renewable power notification indicates the state of the renewable power generation, wherein the state of the renewable power generation is above a threshold amount of renewable power generation.

3. The system of claim 1, wherein the renewable power notification indicates the state of the renewable power generation, wherein the state of the renewable power generation is beneath a threshold amount of renewable power generation.

4. The system of claim 1, wherein the renewable power availability detection component is configured to determine the availability of the renewable power generation based at least in part on the message, wherein the message provides an indication of recent environmental conditions around at least one renewable power generation facility supplying power to the power grid.

5. The system of claim 4, wherein the recent environmental conditions around the at least one renewable power generation facility comprise an amount of wind occurring around a wind power generation facility, an amount of cloud cover occurring around a solar power generation facility, an amount of water flowing through a hydro power generation facility, or a temperature of water from a geothermal power generation facility, or a combination thereof.

6. The system of claim 1, wherein the renewable power availability detection component is configured to determine the availability of the renewable power generation based at least in part on the message, wherein the message provides an indication of environmental conditions that are expected to occur in the future around at least one renewable power generation facility supplying power to the power grid.

7. The system of claim 1, wherein the renewable power availability detection component is configured to determine the availability of the renewable power generation based at least in part on the message, wherein the message provides an indication of a current amount of renewable power generation supplied by at least one renewable power generation facility supplying power to the power grid.

8. The system of claim 1, wherein the renewable power availability detection component is configured to determine the availability of the renewable power generation based at least in part on the message, wherein the message provides an indication of an expected amount of renewable power generation to be supplied by at least one renewable power generation facility supplying power to the power grid in the future.

9. The system of claim 1, wherein the renewable power availability detection component is configured to determine the availability of the renewable power generation based at least in part on current environmental conditions or expected environmental conditions, or both, and historical data relating an amount of renewable power generation supplied by at least one renewable power generation facility supplying power to the power grid in the past when similar environmental conditions occurred.

10. The system of claim 1, comprising a customer database containing enrollment preferences associated with the consumer, wherein the customer notification determination component is configured to determine whether to issue the renewable power notification to the consumer based at least in part on whether the availability of the renewable power generation meets a consumer selectable threshold indicated in enrollment preferences of the customer database.

11. An article of manufacture comprising:
one or more tangible, machine-readable media comprising processor-executable instructions, the instructions comprising:
instructions to receive at least one renewable power generation indication relating to renewable power generation on a power grid;
instructions to determine a current or expected amount of renewable power generation supplied to the power grid, or both, based at least in part on the at least one renewable power generation indication;
instructions to receive customer enrollment preferences, wherein the customer enrollment preferences indicate whether a consumer desires to be notified based at least in part on the current or expected amount of renewable power generation, or both;
instructions to compare customer enrollment preferences to the current or expected amount of renewable power generation, or both; and
instructions to cause a notification to be issued to the consumer when the customer enrollment preferences indicate the consumer desires to receive the notification.

12. The article of manufacture of claim 11, wherein the instructions to receive the at least one renewable power generation indication comprise instructions to receive:
an indication of recent environmental conditions around at least one renewable power generation facility;
an indication of expected future environmental conditions around the at least one renewable power generation facility;
an indication of a measured amount of renewable power generation currently being supplied by the at least one renewable power generation facility; or
an indication of historical data relating the amount of renewable power generation supplied by the at least one renewable power generation facility occurring in the past; or
any combination thereof.

13. The article of manufacture of claim 11, wherein the instructions to receive the at least one renewable power generation indication comprise instructions to receive an indication of a measured amount of power currently being generated by at least one renewable power generation facility.

14. The article of manufacture of claim 11, wherein the instructions to receive the customer enrollment preferences comprise instructions to receive an indication of a type of renewable power generation about which to notify the consumer.

15. The article of manufacture of claim 11, wherein the instructions to receive the customer enrollment preferences comprise instructions to receive the customer enrollment preferences, wherein the customer enrollment preferences indicate that the consumer is to be notified when renewable power generation exceeds a threshold percentage of total power generation supplied to the power grid.

16. The article of manufacture of claim 11, wherein the instructions to receive the customer enrollment preferences comprise instructions to receive the customer enrollment preferences, wherein the customer enrollment preferences indicate that the consumer is to be notified when renewable power generation causes a percentage of total power generation due to carbon-based power generation supplied to the power grid to fall beneath a threshold.

17. The article of manufacture of claim 11, wherein the instructions to cause the notification to be issued to the consumer comprise instructions to cause the consumer to be notified via phone, email, text message, or social media, or any combination thereof.

18. The article of manufacture of claim 11, wherein the instructions to cause the notification to be issued to the consumer comprise instructions to issue the notification to a smart power meter associated with the consumer.

19. A method comprising:
receiving in a power meter a first renewable power notification from a utility indicating that renewable power has met or exceeded a threshold; and
upon receipt of the first renewable power notification, issuing from the power meter a first control signal to control a load to cause the load to consume more power.

20. The method of claim 19, comprising receiving in the power meter a second renewable power notification from the utility indicating that renewable power has fallen beneath the threshold and, upon receipt of the second renewable power notification, issuing from the power meter a second control signal to control the load to cause the load to consume less power.
